(19) United States
(12) Patent Application Publication
(10) Pub. No.: US 2017/0167741 A1
(43) Pub. Date: Jun. 15, 2017

(54) AIR CONDITIONING PARAMETER GENERATION APPARATUS, AIR CONDITIONING OPERATIONAL EVALUATION APPARATUS, METHOD AND NON-TRANSITORY COMPUTER READABLE MEDIUM

(71) Applicant: KABUSHIKI KAISHA TOSHIBA, Tokyo (JP)

(72) Inventors: Tomoshi OTSUKI, Kawasaki (JP); Mitsunobu YOSHIDA, Kawasaki (JP)

(21) Appl. No.: 15/265,977

(22) Filed: Sep. 15, 2016

(30) Foreign Application Priority Data
Dec. 14, 2015 (JP) 2015-243538

(51) Int. Cl. F24F 11/00; G05B 19/042

(52) U.S. Cl. CPC F24F 11/0012; F24F 11/006; G05B 19/0428; F24F 2011/0075; F24F 2011/0013; F24F 2011/0061; G05B 2219/2614

(57) ABSTRACT

An air conditioning parameter generation apparatus as one aspect of the present invention includes a processor configured to execute a program to provide at least a heat flow detector and a parameter value determiner. The heat flow detector detects a heat flow flowing into or flowing out from a first region where an air conditioner adjusts air conditioning. The parameter value determiner determines a value of a parameter for calculating a magnitude of a heat flow rate of the heat flow on the basis of change in measurement temperature of the first region.

### CROSS-REFERENCE TO RELATED APPLICATION(S)

This application is based upon and claims the benefit of priority from Japanese Patent Application No. 2015-243538, flied Dec. 14, 2015; the entire contents of which are incorporated herein by reference.

### FIELD

An embodiment relates to an air conditioning parameter generation apparatus, an air conditioning operational evaluation apparatus, a method and a non-transitory computer readable medium.

### BACKGROUND

In recent years, various efforts have been taken to efficiently use energy. Even in facilities such as a building, efforts to change operation of air conditioners and the like in a building have been taken to comply with laws relating to energy saving, or to acquire a LEED (leadership in energy and environmental design) certification. During a time period with large energy consumption, for example, setting change is performed so that a preset temperature for air conditioner is automatically changed to save energy. Operational change, such as the change in a preset temperature for air conditioner described above, change in working hours, operating time shift, and the like, can change distribution of an energy consumption pattern in a facility, and thus an effect, such as peak shift of electric power and reduction in electricity rates, can be achieved.

Some methods are known as a method for evaluating operational change. For example, a method of performing evaluation while precise physical simulator is generated can acquire an accurate evaluation result, but requires a large number of kinds of parameter tuning to cause very large costs. In addition, a method using a black box model based on a regression method or the like without using a physical model is low cost, but also has low accuracy.

In contrast, a method of combining a parameter based on actual energy use data can estimate operational information at a relatively low cost and with high accuracy. However, for example, a method of calculating how much energy will be consumed after operation of an apparatus is changed, on the basis of power consumption by using simulation, requires an electric power sensor for collecting actual energy use data, which causes additional costs. Thus, it is important to quickly evaluate an effect of energy saving and the like, under a condition where changing operations of air conditioners or the like are assumed, by estimating operational information that is difficult to be collected, such as a heat penetration rate, outer cover heat loss, air conditioner power, a heat value per a living body, and a sunshine coefficient.

### BRIEF DESCRIPTION OF THE DRAWINGS

FIG. 1 is a block diagram illustrating an example of a schematic configuration of an air conditioning operational evaluation apparatus according to one embodiment of the present invention;

FIG. 2 is a diagram illustrating an example of information on a target facility generated on the basis of positional information;

FIG. 3 is a diagram illustrating an example of measurement result information;

FIGS. 4A and 4B are diagrams illustrating an example of air conditioner use information and air conditioner use calculation information;

FIG. 5 is a diagram illustrating an example of a zone;

FIG. 6 is a diagram illustrating another example of a zone;

FIG. 7 is a diagram illustrating an example of a heat flow in a zone;

FIG. 8 is a diagram illustrating another example of a heat flow in a zone;

FIG. 9 is a diagram illustrating an example of a parameter candidate group and parameters as components thereof;

FIG. 10 is a diagram illustrating an example of estimated temperature;

FIG. 11 is a diagram illustrating calculation of evaluation values;

FIG. 12 is a diagram to explain calculation of optimum parameters;

FIG. 13 is a diagram illustrating an example of output;

FIG. 14 is a flow chart of schematic processing of the air conditioning operational evaluation apparatus according to one embodiment of the present invention; and

FIG. 15 is a block diagram illustrating an example of a configuration of hardware achieving the air conditioning operational evaluation apparatus according to one embodiment of the present invention.

### DETAILED DESCRIPTION

In the following, embodiments according to the present invention will be described. The present invention is not limited to the embodiments. For example, an air conditioning parameter generation apparatus as one aspect of the present invention includes a processor configured to execute a program to provide at least a heat flow detector and a parameter value determiner. The heat flow detector detects a heat flow flowing into or flowing out from a first region where an air conditioner adjusts air conditioning. The parameter value determiner determines a value of a parameter for calculating a magnitude of a heat flow rate of the heat flow on the basis of change in measurement temperature of the first region.

### One Embodiment of the Present Invention

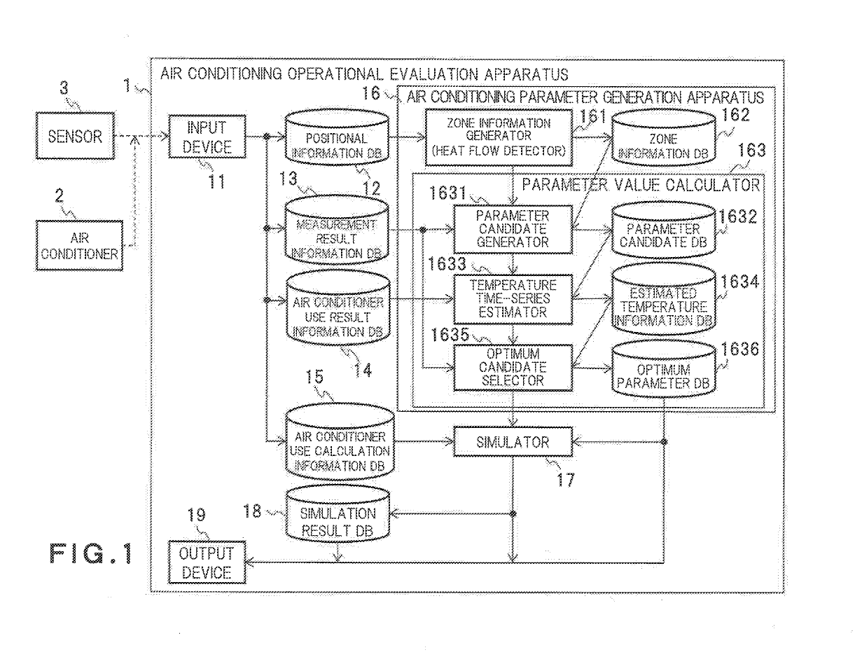

FIG. 1 is a block diagram illustrating an example of a schematic configuration of an air conditioning operational evaluation apparatus according to one embodiment of the present invention. An air conditioning operational evaluation apparatus 1 according to the present embodiment includes an input device (acquirer) 11, a positional information database (DB) 12, a measurement result information DB 13, an air conditioner use result information DB 14, an air conditioner use calculation information DB 15, an air conditioning parameter generation apparatus 16, simulator 17, a simulation result DB 18, and an output device 19.

The air conditioning parameter generation apparatus 16 includes a zone information generator (a heat flow detector) 161, a zone information DB 162, and a parameter value calculator (parameter value determiner) 163. The parameter value calculator 163 includes a parameter candidate generator 1631, a parameter candidate DB 1632, a temperature time-series estimator 1633, an estimated temperature information DB 1634, an optimum candidate selector 1635, and an optimum parameter DB 1636.

The air conditioning operational evaluation apparatus 1 simulates a state (operation) of the air conditioner 2 or an effect after operation of the air conditioner 2 is changed to evaluate the operation. Here, it is assumed that the air conditioning operational evaluation apparatus 1 is capable of transmission and reception of data with the air conditioner 2 and a sensor 3 through a communication interface, a network, and the like.

One or more air conditioners 2 are provided in a target facility, and a state (operation) of the air conditioner 2 is evaluated by the air conditioning operational evaluation apparatus 1. Here, although description is based on assumption that the state of the air conditioner 2 is start (turning on) or stop (turning off) thereof, turning on and off of setting provided in the air conditioner 2 may be included. For example, if the air conditioner 2 includes setting, such as a mode of saving electric power to reduce electric power consumed during operation of the air conditioner 2, and a boost mode of rapidly changing temperature, operation may include a state of turning on and off of the modes.

A plurality of sensors 3 is provided in the target facility, and is, for example, thermometers each of which measures temperature of a region where it is provided. Here, it is assumed that the sensor 3 can transmit data on measured temperature and the like to an external device. The target facility may include an outdoor area, such as a garden and an atrium. The sensor 3 may detect not only temperature but also a living body or Illuminance of sunshine.

Hereinafter, each component of the air conditioning operational evaluation apparatus 1 will be described.

An input device 11 receives input of data to be used for processing in the air conditioning parameter generation apparatus 16 and the simulator 17. Information to be acquired includes positional information, measurement result information, air conditioner use information, air conditioner use calculation information, and the like. These kinds of Information will be described in detail. The input device 11 transmits received information to each DB which stores information therein.

The positional information DB 12 stores positional information transmitted from the input device 11. The positional information is used to grasp structure of a facility as a target, or position of equipment provided in the facility. For example, the positional information includes position, length, thickness, and the like of each of walls, windows, doors, and the like, provided in the target facility. In addition, the positional information includes data such as position of the air conditioner 2 and the sensor 3. In addition to the data, the positional information also may include position of an illuminator, furniture, a person, and the like, existing in the target facility. Further, the positional information also may include not only position of matters existing in the target facility, but also information related to characteristics of the matters. The positional information may include, for example, a target region where the sensor 3 measures temperature, and a target region where the air conditioner 2 adjusts temperature.

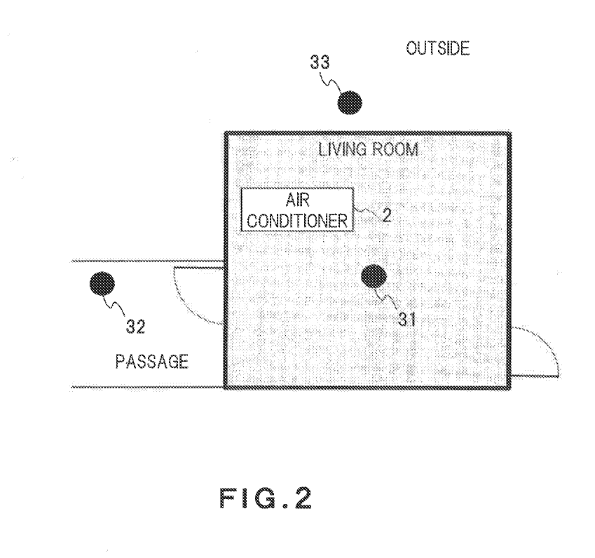

A display format of the positional information is not particularly limited. For example, the display format may be coordinates based on a reference point, or Information showing a relation between positions relative to each other. FIG. 2 is a diagram illustrating an example of information on a target facility generated on the basis of positional information. Each of filled circles shows the sensor 3. FIG. 2 illustrates three sensors such as a sensor 31 that measures temperature of a region surrounded by a black frame, being a living room, a sensor 32 that measures temperature of a passage adjacent to the living room, and a sensor 33 that measures external temperature. The air conditioner 2 adjusts temperature of the living room as a target area. The positional information may identify relative positions among a block, an air conditioner, a thermometer, and the like in the target facility, as with FIG. 2.

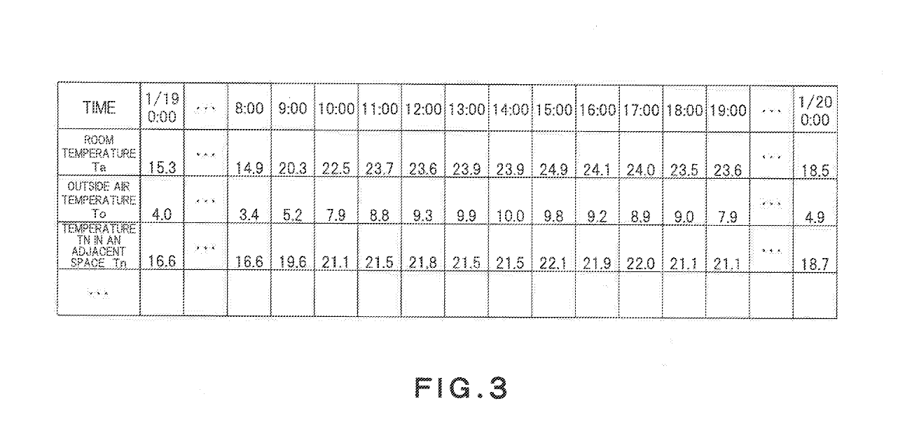

The measurement result information DB 13 stores measurement result information transmitted from the input device 11. The measurement result information is data on temperature measured by each of the sensors 3. FIG. 3 is a diagram illustrating an example of measurement result information. FIG. 3 illustrates actual indoor temperature Tₐ, outside air temperature (outdoor temperature) Tₒ, and temperature Tₙ in an adjacent space, per hour for one day. A time of measurement or a time interval may be appropriately determined. For example, a fine time interval such as per minute is available. In addition, temperature for a plurality of days instead of one day is available. In a case where the plurality of sensors 3 measure the same place such as a case where two sensors 3 measure the Indoor temperature Tₐ, two indoor temperatures measured are identified as Tₐ₁ and Tₐ₂.

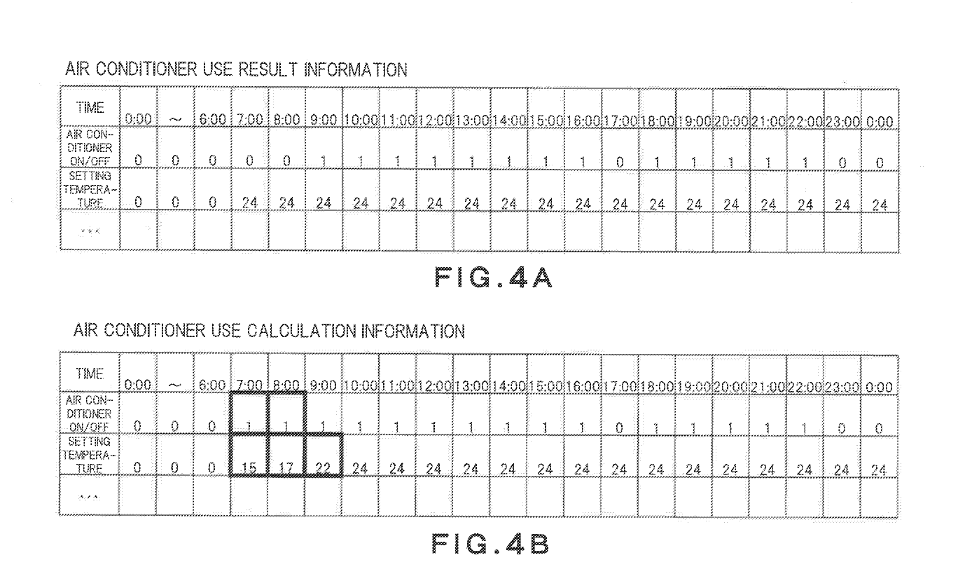

The air conditioner use result information DB 14 stores air conditioner use result information transmitted from the input device 11. The air conditioner use result information is data showing actual use results of the air conditioner 2. FIGS. 4A and 4B are diagrams illustrating an example of air conditioner use information and air conditioner use calculation information. FIG. 4A illustrates air conditioner use result information. The second line shows a state of the air conditioner per hour by designating 1 as turning-on, and 0 as turning-off. The third line shows a preset temperature per hour. In this way, information on actual states of the air conditioner and preset temperatures is shown in chronological order.

The air conditioner use result information may include information other than that. For example, if the air conditioner 2 itself measures suction temperature or blow-out temperature of the air conditioner 2, the measured temperatures may be included. In addition, the air conditioner use result information may include information on whether setting provided in the air conditioner 2, such as a mode of saving electric power used for operation, and a boost mode of rapidly changing temperature, is effective. A time interval of the air conditioner use result information may be appropriately determined, and a time at the time of change may be recorded. Further, information on a target region where the air conditioner 2 adjusts temperature may be included in the air conditioner use result information instead of the positional information.

The air conditioner use calculation information DB 15 stores air conditioner use calculation information, transmitted from the input device 11. While the air conditioner use result information shows actual use results, the air conditioner use calculation information is date generated to simulate an effect when operation of the air conditioner 2 is changed. As described later, the simulator 17 simulates temperature change in a target region (zone) of simulation after a predetermined time elapses, when operation (such as preset temperature) of the air conditioner 2 is changed. That is, the air conditioner use calculation information is data inputted to the simulator 17.

FIG. 4B illustrates the air conditioner use calculation information. Sections surrounded by black frames are different from the air conditioner use result information. As described above, the air conditioner use calculation information is the same format as that of the air conditioner use result information, and some of values are changed by a user or another system to allow an effect by the change to be simulated. FIG. 4B is used to simulate operation intending to save energy by turning on the air conditioner in early morning.

The air conditioning parameter generation apparatus 16 generates an appropriate parameter on the basis of the positional information, the measurement result information, and the air conditioner use result information. The parameter is necessary to calculate the amount of heat in a target region (zone) of simulation to be performed by the simulator 17.

To simulate an effect of operational change, it is necessary to predict temperature change caused by the effect of operational change. To acquire the temperature change, it is necessary to estimate the amount of heat flowing into the zone or flowing out from the zone.

Here, for convenience, a heat flowing into the zone or flowing out from the zone is particularly referred to as a heat flow, and amount of heat of the heat flow is particularly referred to as a heat flow rate. a magnitude of heat flow rate represents amount of heat.

The temperature change in the zone is determined by not only a heat flow rate from the air conditioner 2 but also all heat flow rates included in the zone. For example, the temperature change is affected by a heat flow rate penetrating through a wall in the zone, a heat flow rate emitted from a living body existing in the zone, a heat flow rate caused by sunshine emitted through a window included in the zone, and the like. Magnitudes (the amount of heat) and directions of these heat flow rates determine the temperature change in the zone. Thus, the air conditioning parameter generation apparatus 16 first grasps the zone, and estimates the number of heat flow rates and kinds thereof included in the zone. Then, the air conditioning parameter generation apparatus 16 predicts a parameter value necessary to calculate a magnitude of each of the heat flow rates.

Details of the parameter and specific processing of the air conditioning parameter generation apparatus 16 will be described along with internal structure of the air conditioning parameter generation apparatus 16.

The zone information generator 161 generates zone information on the basis of positional information acquired from the positional information DB 12. The zone information relates to a zone determined by the zone information generator 161, a heat flow rate of the zone, a parameter of the heat flow rate, and the like, determined by the zone information generator 161.

First, determination of a zone will be described. The zone information generator 161 generates a region (target region of the air conditioner) where the air conditioner 2 adjusts temperature, from positional information on the air conditioner 2. Then, the zone information generator 161 determines a zone from positional information on the sensor 3 in the region where temperature is adjusted.

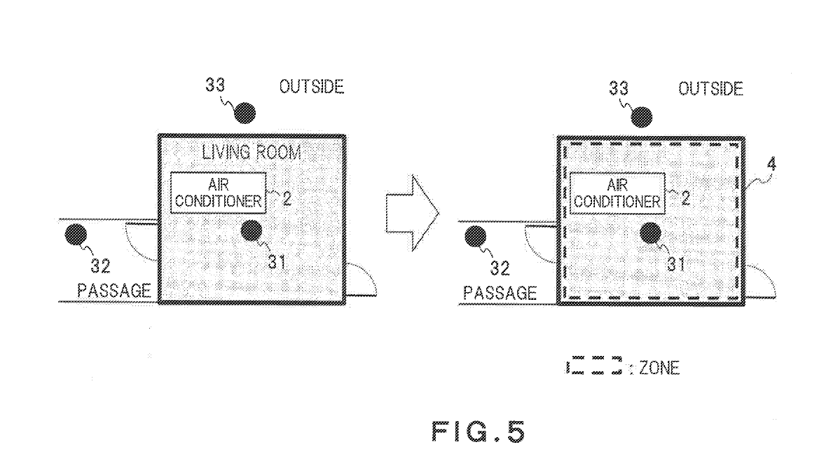

FIG. 5 is a diagram illustrating an example of a zone. A zone 4 is illustrated by a thick-bordered box with a dotted line. FIG. 5 illustrates a case where one sensor 3 is provided in a living room that is a target region of air conditioning by the air conditioner 2. In this case, the target region itself of the air conditioner 2 may be determined as the zone. Accordingly, all of the living room that is the target region of the air conditioner coincides with the zone 4 in FIG. 5.

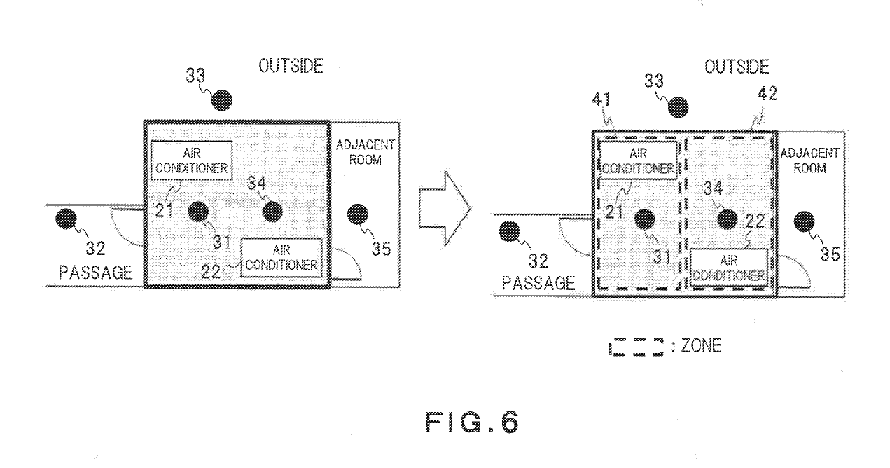

FIG. 6 is a diagram illustrating another example of a zone. FIG. 6 illustrates a case where a plurality of sensors 3 is provided in a target region of air conditioning. In this case, the target region of air conditioning is divided into a plurality of zones. In FIG. 6, two sensors 31 and 34 exist in the target region of air conditioning, and thus the target region of air conditioning is divided into two zones 41 and 42. A method of dividing the zone is appropriately determined, and is not limited to one method. For example, the method includes the Voronol tessellation method of dividing one region into a plurality of regions on the basis of which of the sensors 31 and 34 is closer to each of the plurality of regions. In FIG. 6, while two air conditioners 2 of air conditioners 21 and 22 exist, a target region of air conditioning by both the air conditioners is the same living room.

Next, the zone information generator 161 estimates existence of a heat flow rate in this zone. The heat flow rate, for example, includes a heat flow rate by an air conditioner, a heat flow rate from the outside, a heat flow rate from an adjacent area or zone, a heat flow rate from fever of a living body existing in the zone, a heat flow rate caused by sunshine through a window, and the like.

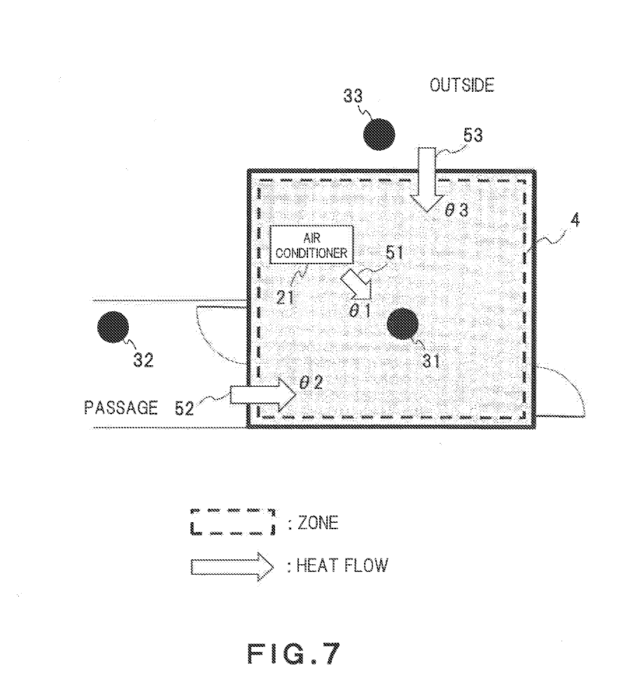

FIG. 7 is a diagram illustrating an example of a heat flow in a zone. FIG. 7 illustrates an example of the zone illustrated in FIG. 5. In FIG. 7, the air conditioner 2 exists in the zone 4, and thus a heat flow rate 51 flowing out from the air conditioner 2 exists in the zone 4. The zone 4 is adjacent to a passage and the outside, and thus there are a heat flow rate 52 flowing into and flowing out between the zone and the passage, and a heat flow rate 53 flowing into and flowing out between the zone and the outside.

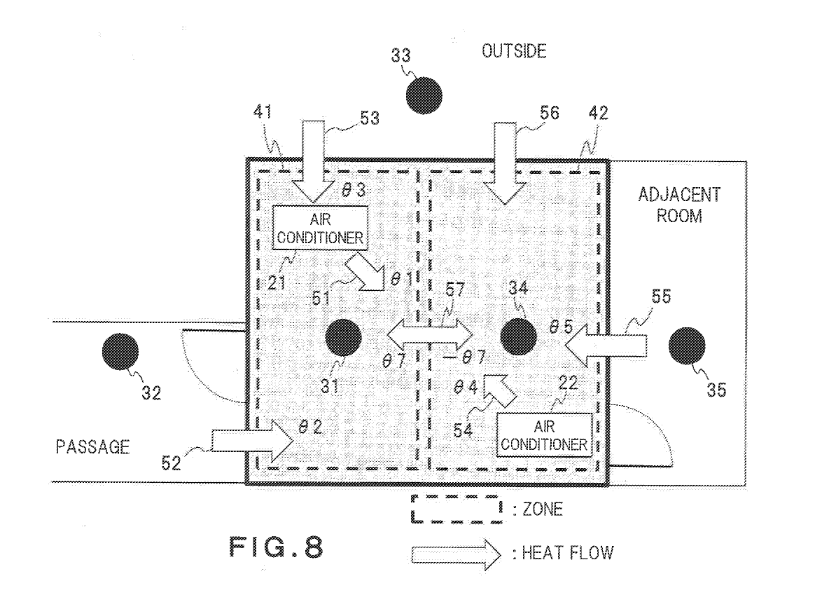

FIG. 8 is a diagram illustrating another example of a heat flow in a zone. FIG. 8 illustrates an example of the zone illustrated in FIG. 6. In FIG. 8, a zone 41 on a left side includes the heat flow rate 51 from an air conditioner 21, the heat flow rate 52 from the passage, the heat flow rate 53 from the outside existence, and a zone 42 on a right side includes a heat flow rate 54 from the air conditioner 2, a heat flow rate 55 from an adjacent room, and a heat flow rate 56 from the outside. The zones 41 and 42 are adjacent to each other, and thus a heat flow rate 57 between the zones exists in both the zones.

If a sensor detects whether there is a person in a zone, or detects sunshine or the like, a heat flow rate emitted from the person in the zone and a heat flow rate of sunshine from a window may be considered. As described above, the zone information generator (the heat flow detector) 161 estimates existence of a heat flow rate flowing into the zone or flowing out from the zone from the air conditioner 2 in a zone, another adjacent region, another positional information, and the like and detect a heat flow.

Subsequently, the zone information generator 161 determines a kind of a parameter for each of heat flow rates to acquire a magnitude of each of the heat flow rates.

The following expression (1) expresses a heat balance expression in a zone. The heat balance expression expresses a relationship between temperature fluctuation in the zone and a heat flow rate in the zone. The temperature fluctuation per unit time in the zone depends on the heat flow rate per unit time in the zone. In a case where temperature fluctuation per unit time “i” in a zone is indicated as ΔT, the product of specific heat Cᵥ in the zone and the ΔT is equal to a sum total of the amount of heat flowing into the zone and flowing out from the zone during the unit time “i”. Thus, if the heat flow rate is expressed by a right side linear expression, the following heat balance expression is satisfied.

$$\begin{matrix}[ Expression 1 ] & \\ Cv Δ T = {\sum }_{k = 1}^{K} {a}_{ki} {θ}_{k} & ( 1 )\end{matrix}$$

The “K” is a total number of heat flow rates flowing into the zone and flowing out from the zone, and is an integer of 1 or more. The “k” is flow number imparted to heat flow rates, and is indicated as k=(1, 2, . . . , K).

The “i” designates a unit time, but hereafter means a number of a unit time included in a unit period where simulation is performed, or a time slot, and is indicated as i=(1, 2, . . . , I). The “I” is an integer of 1 or more. For example, if simulation for one day is performed by using a unit time of one hour, the “I” is 24, and the “i” of 1 designates a time slot from 0 o'clock to 1 o'clock, the “i” of 2 designates a time slot from 1 o'clock to 2 o'clock, and the “I” of 24 designates a time slot from 23 o'clock to 24 o'clock.

The aₖₗθₖ on the right side of the expression (1) means the k-th heat flow rate in a time slot “i”. The aₖₗ and the parameter θₖ determine a magnitude of a heat flow rate. Here, the aₖᵢ is defined as a coefficient that can be calculated from measurement result information or the like, and the parameter θₖ is defined as a coefficient that cannot be calculated from the measurement result information.

For example, it is thought that a heat flow rate caused by the air conditioner 2 depends on difference between a preset temperature of the air conditioner 2 and a temperature of a zone, and thus a parameter for calculating a magnitude of the heat flow rate on the basis of the difference is determined as a parameter of the air conditioner 2. Then, the parameter corresponds to power of the air conditioner 2. When the air conditioner 2 does not actually operate in the time, a magnitude of the heat flow rate should be 0 (zero). Thus, the parameter needs to be multiplied by an On-Off function that indicates 1 when the air conditioner 2 is turned on, and indicates 0 when the air conditioner 2 is turned off.

It is thought that a heat flow rate with respect to an adjacent space depends on difference between a temperature of the adjacent space and a temperature of the zone, and thus a parameter for calculating a magnitude of the heat flow rate on the basis of the difference between the temperature of the adjacent space and the temperature of the zone is determined as a parameter of a heat flow rate with respect to the adjacent space. The parameter corresponds to outer cover heat loss of a wall, a door, a ceiling, and the like, existing between the zone and an adjacent space, such as an adjacent room, a passage, or the outside.

In addition, a heat flow rate from fever of a living body can be acquired by an average heat value per person and a coefficient of the number of existing persons in the zone, and thus the average heat value per person may be determined as a parameter. Further, a heat flow rate caused by sunshine which irradiates the region through a window can be acquired by using a coefficient of the amount of the sunshine and a heat penetration rate of the window, and thus the heat penetration rate of the window may be determined as a parameter.

In FIG. 7, parameters of the heat flow rates 51 to 53 are indicated as θ₁ to θ₃, respectively. In FIG. 8, parameters of the heat flow rates 51 to 56 are indicated as θ₁ to θ₆, respectively. The heat flow rate 57 between the zones is an inflow for one zone, and is an outflow for the other zone, having the same magnitude (amount of heat) as that of the inflow. Thus, the heat flow rate 57 has one parameter that can be indicated as a reference character opposite to that of the other parameter. In FIG. 8, a parameter of the heat flow rate 57 in the zone 41 is indicated as θ₇, and a parameter of the heat flow rate 57 in the zone 42 is indicated as −θ₇.

In addition, each parameter in the zone is collectively indicated as one group of parameters (parameter group) of the zone. Here, the parameter group is indicated as a set S=(θ₁, . . . θₖ, . . . , θ_{K}). Thus, a parameter group of the zone 4 in FIG. 7 is indicated as S=(θ₁, θ₂, θ₃). In addition, a parameter group in the zone 41 in FIG. 8 is indicated as S=(θ₁, θ₂, θ₃, θ₇), and a parameter group of the zone 42 in FIG. 8 is indicated as S=(θ₄, θ₅, θ₆, −θ₇). Inflow and outflow each are a direction of a heat flow rate, and any of which may be indicated as a positive or negative parameter.

Zone information includes the zone, the heat flow rate in the zone, the parameter group, and the like, generated by the zone information generator 161 as described above. In addition, the zone information may include another information on the zone that is equipment, such as the air conditioner 2, existing in the zone, and a positional relationship.

The zone information DB 162 stores the zone information generated by the zone information generator 161. The zone information stored is used for processing of the parameter value calculator 163. The zone information may be directly transmitted to the parameter value calculator 163 from the zone information generator 161. In that case, the zone information DB 162 may be unnecessary.

The parameter value calculator 163 calculates an appropriate value for each parameter in a parameter group of a zone. A method of calculating the value will be described below along with internal structure of the parameter value calculator 163.

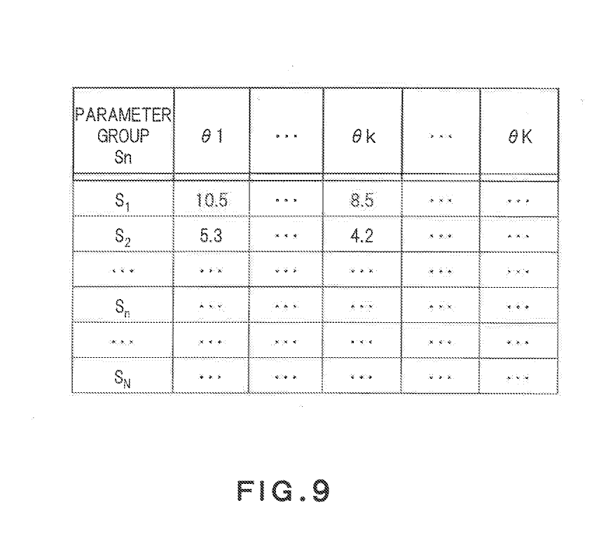

The parameter candidate generator 1631 acquires the zone information from the zone information generator 161 or the zone information DB 162, and determines a candidate value of each parameter in a parameter group S. Here, a parameter value determined by the parameter candidate generator 1631 is referred to as a parameter candidate, and a set of parameter candidates is referred to as a parameter candidate group. Among a plurality of parameter candidate groups generated, the n-th (“n” is an integer satisfying a relation of 1≦n≦N, and “N” is an Integer of 1 or more) parameter candidate group is indicated as Sn. FIG. 9 is a diagram illustrating an example of a parameter candidate group and parameters as components thereof. A value of each parameter in the plurality of parameter candidate groups is recorded. The “N” is predetermined.

A public known method may be used for a method of determining a parameter value by using the parameter candidate generator 1631. For example, the parameter value may be randomly generated while upper and lower limit values of each parameter are provided corresponding to a kind of each parameter, or an expected value of each parameter may be used. Alternatively, each parameter in a parameter candidate group S1 being an initial value is randomly generated, and each parameter in subsequent parameter candidate groups S₂ to S_{N} may be determined by using optimization algorithms, such as a gradient method, a genetic algorithm (GA) method, a simulated annealing (SA), and a downhill simplex method. In addition, such a method of comprehensively searching a parameter space may be used. Using these algorithms may accurately and rapidly acquire an optimum value or a quasi-optimum value with a less number of trials.

Upper and lower limit values of each parameter may be predetermined in the parameter candidate generator, or stored in the parameter candidate DB 1632 or the like to be referred.

The parameter candidate DB 1632 stores a parameter candidate group generated by the parameter candidate generator 1631. The parameter candidate group stored is used for processing of the temperature time-series estimator 1633. The parameter candidate group may be directly transmitted to the temperature time-series estimator 1633 from the parameter candidate generator 1631. In that case, the parameter candidate DB 1632 may be unnecessary.

The temperature time-series estimator 1633 acquires a parameter candidate group from the parameter candidate generator 1631 or the parameter candidate DB 1632, and estimates a value of temperature change in a predetermined period by the parameter candidate group.

A method of creating estimated temperature by using the temperature time-series estimator 1633 will be described. While the ΔT of the heat balance expression expressed by the expression (1) indicates temperature fluctuation per unit time, the ΔT can be expressed as follows: ΔT=T[i+1]−T[i], where actual temperature measured in a time slot i is indicated as T[i], and actual temperature of a time slot i+1 is indicated as T[i+1], and thus the expression (1) can be changed like the following expression.

$$\begin{matrix}[ Expression 2 ] & \\ T [ i + 1 ] = T [ i ] + \frac{1}{{C}_{v}} {\sum }_{k = 1}^{K} {a}_{ki} {θ}_{k} & ( 2 )\end{matrix}$$

Here, substituting the actual temperature “T” in the expression (2) with estimated temperature Y forms an time development expression related to the estimated temperature Y, expressed by an expression (3), and thus finding only an initial value Y[1] enables estimated temperature Y[i] in a zone in each time slot to be acquired by repeatedly performing calculation by using this difference expression.

$$\begin{matrix}[ Expression 3 ] & \\ Y [ i + 1 ] = Y [ i ] + \frac{1}{{C}_{v}} {\sum }_{k = 1}^{K} {a}_{ki} {θ}_{k} & ( 3 )\end{matrix}$$

The Initial value Y[1] may be estimated by using an average value of the actual temperature T[1] and the like.

A value of aₖᵢ that is a coefficient of a heat flow rate of a flow number “k” in the time slot “i” is calculated from the measurement result information. The aₖᵢ is different for each kind of heat flow rate. For example, in a case where a heat flow rate caused by the air conditioner 2 is indicated as a₁ᵢ, the a₁ᵢ is expressed as follows: a₁ᵢ=(Tₛₑₜ[i]−Tₐ[i])On-Off[i], because the a₁ᵢ is based on the product of a difference between a preset temperature Tₛₑₜ of the air conditioner 2 and a room temperature Tₐ in a target region of temperature adjustment of the air conditioner 2, and an On-Off function indicating a value of turning on and turning off of the air conditioner. In addition, in a case where a heat flow rate between a zone and an adjacent space, such as an adjacent room is indicated as a₂ᵢ, the a₂ᵢ is expressed as follows: a₂ᵢ=Tₙ[i]−Tₐ[i], because the a₂ᵢ is based on a difference between a temperature Tₙ in the adjacent room and the room temperature Tₐ. Further, in a case where a heat flow rate between the zone and the outside is indicated as a₃ᵢ, the a₃ᵢ is expressed as follows: a₃ᵢ=Tₒ[i]−Tₐ[i], because the a₃ᵢ is based on a difference between an outside air temperature Tₒ and the room temperature Tₐ.

The value Tₛₑₜ[i] of preset temperature, the value Tₒ[i] of outside air temperature, and the value Tₙ[i] of temperature of an adjacent zone in the time slot “i” may be an actual temperature at a time in the time slot “i”. Alternatively, these three values may be an average value between time slots. Thus, these three values may be appropriately determined. If the time unit is an hour, for example, temperature at an intermediate time of the time unit, that is, at thirty minutes ahead each o'clock may be used as the values.

In this way, the aₖᵢ is determined to estimate temperature of the zone. For example, the estimated temperature Y in the zone 4 illustrated in FIG. 7 can be acquired by the following expression.

$$\begin{matrix}[ Expression 4 ] & \\ Y [ i + 1 ] = Y [ i ] + \frac{1}{{C}_{v}} \{ ( {T}_{set} [ i ] - T [ i ] ) OnOff [ i ] {θ}_{1} + ( {T}_{n} [ i ] - T [ i ] ) {θ}_{2} + ( {T}_{o} [ i ] - T [ i ] ) {θ}_{3} \} & ( 4 )\end{matrix}$$

Moreover, if there is a plurality of zones as illustrated in FIG. 8, temperature is estimated for each zone. For example, estimated temperature Yₐ₁ in the zone 41 in FIG. 8 is expressed by the following expression using specific heat Cᵥ₁ in the zone 41, preset temperature Tₛₑₜ₁ and turning on and turning off On-Off₁ of the air conditioner 21, temperature Tₙ₁ in a passage, temperature Tₐ₂ in the zone 42, and a parameter group of the zone 41.

$$\begin{matrix}[ Expression 5 ] & \\ {Y}_{a 1} [ i + 1 ] = {Y}_{a 1} [ i ] + \frac{1}{{C}_{v 1}} \{ ( {T}_{set 1} [ i ] - {T}_{a 1} [ i ] ) {OnOff}_{1} [ i ] {θ}_{1} + ( {T}_{n 1} [ i ] - {T}_{a 1} [ i ] ) {θ}_{2} + ( {T}_{o} [ i ] - {T}_{a 1} [ i ] ) {θ}_{3} + ( {T}_{a 1} [ i ] - {T}_{a 2} [ i ] ) {θ}_{7} \} & ( 5 )\end{matrix}$$

In addition, the temperature Tₐ₂ In the zone 42 is expressed by the following expression using specific heat Cᵥ₂ in the zone 42, preset temperature Tₛₑₜ₂ and turning on and turning off On-Off₂ of the air conditioner 21, temperature Tₙ₂ in an adjacent room, external temperature Tₒ, temperature Tₐ i in the zone 41, and a parameter group of the zone 42.

$$\begin{matrix}[ Expression 6 ] & \\ {Y}_{a 2} [ i + 1 ] = {Y}_{a 2} [ i ] + \frac{1}{{C}_{v 2}} \{ ( {T}_{set 2} [ i ] - {T}_{a 2} [ i ] ) {OnOff}_{2} [ i ] {θ}_{4} + ( {T}_{n 2} [ i ] - {T}_{a 2} [ i ] ) {θ}_{5} + ( {T}_{o} [ i ] - {T}_{a 2} [ i ] ) {θ}_{6} + ( {T}_{a 1} [ i ] - {T}_{a 2} [ i ] ) {θ}_{7} \} & ( 6 )\end{matrix}$$

If the specific heat Cᵥ in a zone is unknown, the specific heat Cᵥ may be estimated by simulation or the like, or may be assumed to be any value such as 1 for calculation.

The method of creating estimated temperature by using the temperature time-series estimator 1633 is not limited to the above. The estimated temperature may be calculated on the basis of a parameter θₖ by using simulation such as the Energy Plus.

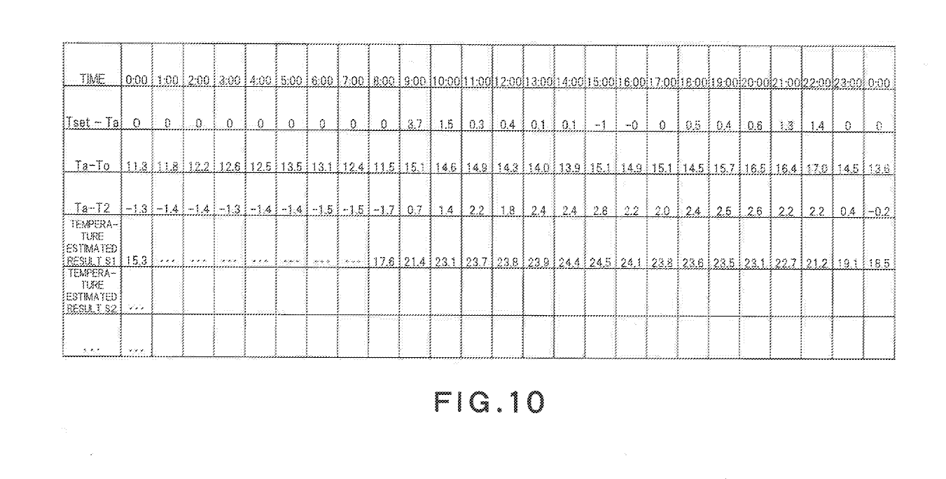

The estimated temperature calculated is transmitted to the estimated temperature information DB 1634 as estimated temperature information. FIG. 10 is a diagram illustrating an example of estimated temperature. The second line to the fourth line in FIG. 10 show aₖᵢ or a value of a temperature difference necessary for calculation of the aₖᵢ. If there is a plurality of sensors, a zone can be divided into a plurality of zones as described above, and thus accuracy of an optimum parameter can be increased as compared with a case of one zone. Accordingly, dividing a zone into a plurality of zones enables simulation using a parameter with high accuracy, and thus there is expected an effect of Increasing accuracy of air conditioner operational evaluation to be finally acquired.

The estimated temperature information DB 1634 stores the estimated temperature information generated by the temperature time-series estimator 1633. The parameter candidate group stored is used for processing of the optimum candidate selector 1635. The estimated temperature information may be directly transmitted to the optimum candidate selector 1635 from the temperature time-series estimator 1633. In that case, the estimated temperature information DB 1634 may be unnecessary.

The optimum candidate selector 1635 compares an estimated result of temperature of each parameter candidate group Sn, the result being generated by the temperature time-series estimator 1633, and an actual temperature value that is actually measured, and then generates an evaluation value (cost value) of evaluating the comparison result. The actual temperature value is acquired from the measurement result information DB 13. A method of calculating an evaluation value may be appropriately determined. For example, the evaluation value can be acquired by a square error such as expressed by the following expression, where an actual temperature value in the time slot “i” is indicated as T[i], and an estimated temperature value therein is indicated as Y[i].

$$\begin{matrix}[ Expression 7 ] & \\ {\sum }_{i = 1}^{I} {( Y [ i ] - T [ i ] )}^{2} & ( 7 )\end{matrix}$$

If there is a plurality of zones, an evaluation value can be acquired by using a sum total of a square error for each zone, and the like. The evaluation value can be acquired by a square error such as expressed by the following expression, where the number of the zones is indicated as “m” (“m” is an integer satisfying a relation of 1≦m≦M, and “M” is an integer of 1 or more), an actual temperature value in the time slot “i” Is indicated as Tₘ[i], and an estimated temperature value therein is indicated as Yₘ[i].

$$\begin{matrix}[ Expression 8 ] & \\ {\sum }_{m = 1}^{M} {\sum }_{i = 1}^{I} {( {Y}_{m} [ i ] - {T}_{m} [ i ] )}^{2} & ( 8 )\end{matrix}$$

A distance function, such as an absolute error and a MAX norm, may be used for a method of calculating an evaluation value.

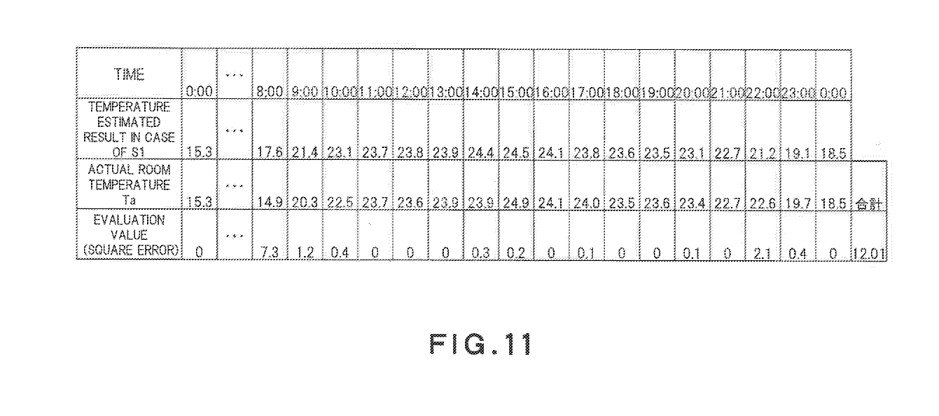

FIG. 11 is a diagram illustrating calculation of evaluation values. The second line in FIG. 11 shows estimated results of temperature of a parameter candidate group S1 in respective time slots. The third line in FIG. 11 shows temperature measured values stored in the measurement result information DB 13. The optimum candidate selector 1635 calculates evaluation values on the basis of the corresponding estimated results of temperature and temperature measured values. The fourth line in FIG. 11 shows square errors in the respective time slots and an evaluation value that is a total value of the square errors. In this way, the optimum candidate selector 1635 generates an evaluation value of the parameter candidate group generated by the parameter candidate generator 1631.

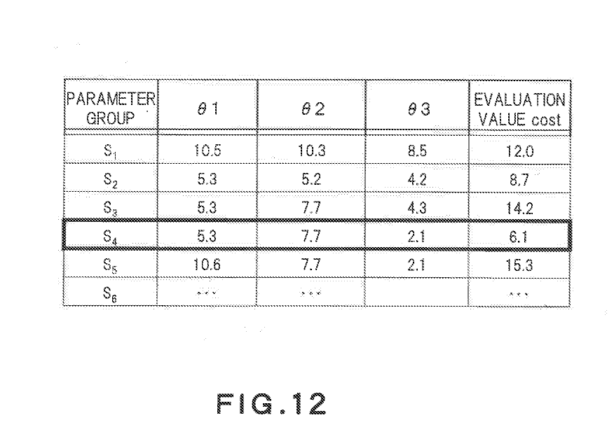

FIG. 12 is a diagram to explain calculation of optimum parameters. In FIG. 12, parameter values of respective parameter candidate groups generated by the parameter candidate generator 1631 and evaluation values calculated by the optimum candidate selector 1635 are recorded. The optimum candidate selector 1635 determines a parameter candidate group having a minimum evaluation value among all of the parameter candidate groups as an optimum parameter group (optimum air conditioning parameter).

Here, it is assumed that the optimum parameter candidate group having a minimum evaluation value is determined to be optimum. However, an optimum parameter candidate group having an evaluation value other than the minimum value may be determined to be optimum. For example, a condition of determining an optimum parameter candidate group may be appropriately determined depending on a method of calculating an evaluation value, such as a condition that an optimum parameter candidate group has an evaluation value closest to a designated value.

The optimum parameter DB 1636 stores an optimum parameter group determined by the optimum candidate selector 1635. The optimum parameter group stored is used for processing of the simulator 17. The optimum parameter group may be directly transmitted to the simulator 17 from the optimum candidate selector 1635. In that case, the optimum parameter DB 1636 may be unnecessary.

The simulator 17 acquires an optimum parameter group from the air conditioning parameter generation apparatus 16, and air conditioner use calculation information from the air conditioner use calculation information DB 15. Then the simulator 17 performs simulation of a case where operation is changed, on the basis of the acquired optimum parameter group and air conditioner use calculation information.

The simulator 17 is feasible by using an existing simulator such as the Energy Plus, for example. In addition, temperature after operation is changed may be estimated by a method similar to that of the temperature time-series estimator 1633.

The simulation result DB 18 stores simulation results generated by the simulator 17.

The output device 19 acquires a simulation result from the simulator 17 or the simulation result DB 18, and outputs the simulation result. The output device 19 also may acquire an optimum parameter used for the simulation from the optimum parameter DB 1636, and may output the optimum parameter.

Information to be outputted from the output device 19 may be determined in response to input from the input device, or may be predetermined. In addition, the output device 19 may output information transmitted. Alternatively, the output device 19 may poll the simulation result DB 18 or the like to acquire information to be outputted.

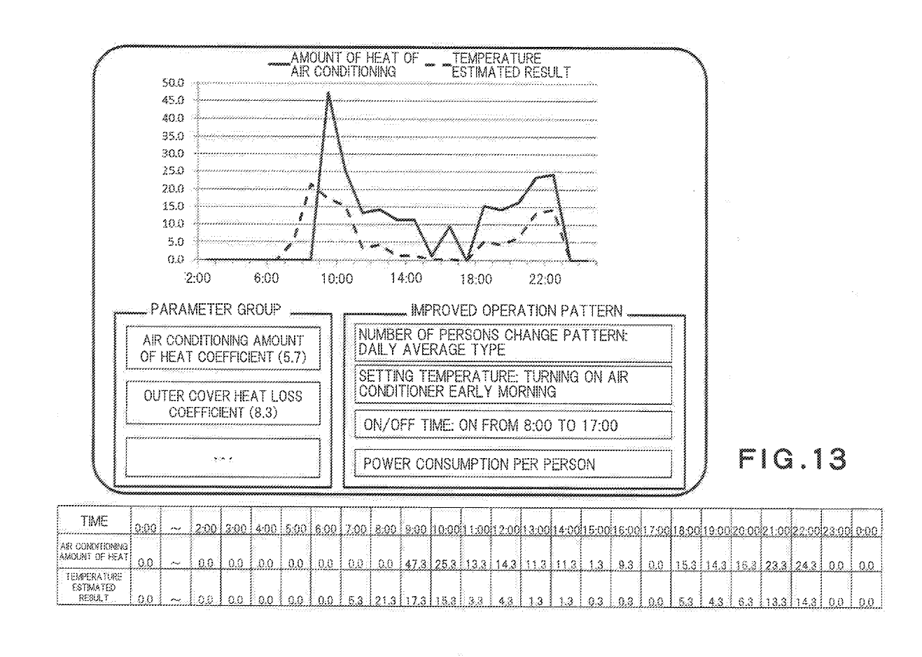

An output format may be GUI output, or data may be outputted as an electronic file. FIG. 13 is a diagram illustrating an example of output. FIG. 13 includes a graph in which a solid line shows the amount of heat from an air conditioner 3 after operation is changed, and a broken line shows estimated temperature after operation is changed, estimated on the basis of an optimum parameter group. The graph may illustrate change in an amount of energy, or a relative value of the energy.

In FIG. 13, optimum air conditioning parameters used for simulation, and air conditioner use calculation information as an improved operational pattern, are outputted along with the graph. Here, operational change, “turning on an air conditioner early morning”, is shown. These kinds of information each may be displayed alone, or displayed in combination with each other. As illustrated in a lower section of FIG. 13, an estimated result of temperature of an optimum parameter, or the like, may be outputted. In addition, an evaluation value of each parameter candidate group, calculated by the optimum candidate selector 1635, may be outputted.

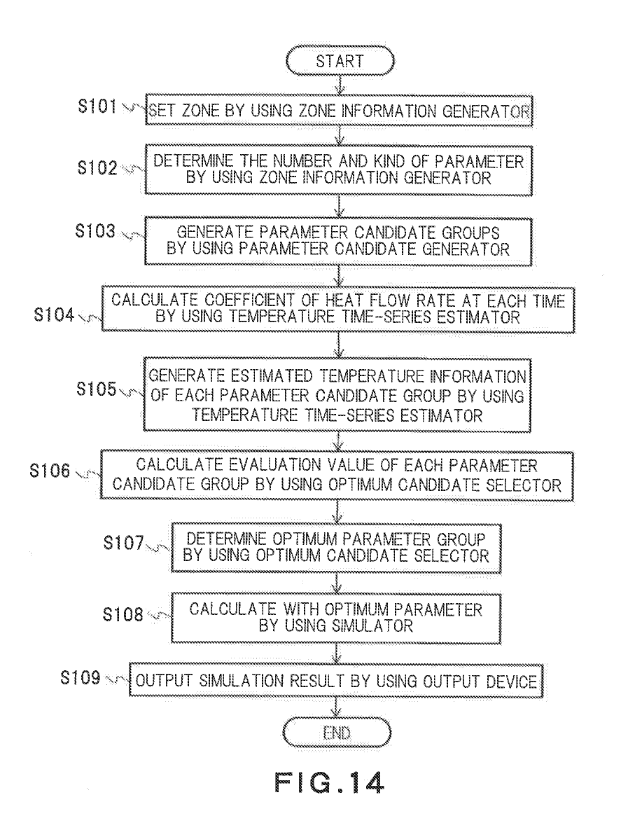

Subsequently, a processing flow of the air conditioning operational evaluation apparatus according to the present embodiment will be described. FIG. 14 is a flow chart of schematic processing of the air conditioning operational evaluation apparatus according to one embodiment of the present invention. In this flow chart, information such as positional information is previously stored in each DB, and processing of the air conditioning parameter generation apparatus 16 is assumed as a start. The present flow may starts at any timing. The present flow may automatically starts at a predetermined timing. In addition, the present flow may start at timing when the start of proceeding of the present flow is instructed trough an Input device 301 or when data in storage such as the positional information DB 12 is updated.

The zone information generator 16 acquires positional information from the positional information DB 12, and sets a zone on the basis of the positional information on the air conditioner 2 and the sensor 3 (S101). Then the zone information generator 16 estimates a heat flow rate in the zone and then determines the number of parameters of the heat flow rate and a kind thereof (S102). The estimation of a heat flow rate is performed on the basis of the air conditioner 2, a relationship between the zone and other regions and the like.

The parameter candidate generator 1631 determines a condition, such as an upper limit value and a lower limit value of the parameter, on the basis of the kind of the parameter. Then, the parameter candidate generator 1631 determines a value of each parameter and generates a plurality of parameter candidate groups (S103). The parameter candidate groups are transmitted to the temperature time-series estimator 1633.

The temperature time-series estimator 1633 determines necessary measurement result information on the basis of a kind of each parameter included in the parameter candidate groups, a heat flow rate thereof or the like and then calculates a coefficient aₖᵢ of the heat flow rate in the zone on the basis of measurement result information (S104). Then the temperature time-series estimator 1633 generates estimated temperature information in each parameter candidate group on the basis of each parameter candidate value in the parameter candidate groups and the coefficient aₖᵢ of the heat flow rate (S105). The estimated temperature information generated is transmitted to the optimum candidate selector 1635.

The optimum candidate selector 1635 acquires measurement result information from the measurement result information DB 13 and then calculates an evaluation value of each parameter candidate group on the basis of the measurement result information and the estimated temperature information (S106). Then, the optimum candidate selector 1635 determines an optimum parameter group on the basis of the evaluation value of each parameter candidate group (S107). The optimum parameter group is transmitted to the simulator 17.

The simulator 17 performs simulation on the basis of the optimum parameter group acquired and then calculates energy information indicates a result of the simulation (S108). The simulation result is outputted through the output device (S109). The flow of schematic processing in the present embodiment has been described above.

While the present flow chart describes processing of each component in a case where the processing is independently performed, the processing of each component may be performed in series. For example, once one parameter candidate group is generated, processing may proceed to generation of an evaluation value of the parameter candidate group. In that case, after the processing from S102 to S106 is performed for one parameter candidate group, the processing returns to S102 again, and then the processing for a subsequent parameter candidate group may be performed. In this case, a termination condition may be applied to omit a calculating time or reduce a load of calculation, and if the termination condition is satisfied, the processing may be finished without creating a designated number of parameter candidate groups. The termination condition may be defined so that a parameter candidate group is determined to be optimum if an evaluation value becomes lower than a predetermined threshold value or if a difference from the last parameter candidate group becomes lower than a predetermined threshold value, for example.

In addition, while the present flow chart describes the processing for one zone, in a case of a plurality of zones, the processing from S101 to S106 may be performed for each of the zones.

It is also thought that calculation of an optimum parameter group in the optimum parameter calculator 163 is assumed as an optimization problem so that there is applied a method of calculating an optimum parameter group by using a mathematical programming problem solver such as the CPLEX.

An optimum parameter group allows the left side (a variation of amount of heat estimated on the basis of change in measurement temperature) of the heat balance expression expressed by the expression 1 to be substantially equal to the right side (a variation of a heat flow rate in a zone) thereof. Accordingly, acquiring an optimum parameter group can be assumed as an optimization problem of acquiring a parameter group which reduces an objective function as small as possible, the objective function being a sum total of a difference or an square error between the left and right sides of the heat balance expression in each time slot “i”. Thus, an optimum parameter group can be calculated by solving an optimization problem expressed by the following expression (9) using a mathematical programming problem solver under a constraint condition such as an upper limit value and a lower limit value of each parameter.

$$\begin{matrix}[ Expression 9 ] & \\ {θ}^{*} = \begin{matrix}arg min \\ θ\end{matrix} {\sum }_{i = 1}^{I} {\{ ( {\sum }_{k = 1}^{K} {a}_{ki} {θ}_{k} ) - {C}_{v} Δ T \}}^{2} & ( 9 )\end{matrix}$$

An optimum value of θ is indicated as θ*.

Alternatively, a solution of the expression (9) above may be acquired by a regression method, assuming that CᵥΔT is an objective variable and that aₖᵢ is an explanatory variable and that each value in the time slot i=(1, 2, . . . , I) is regression indicating a different data point.

The expression (9) above is acquired from a viewpoint of reducing an error between a heat flow rate in each time slot and a temperature rise by the heat flow rate. Other than this, the expression (9) also can be assumed as an optimization problem of acquiring a parameter group that most reduces a sum total of a difference or a square error between an estimated temperature value Y[i] and an actual temperature value T[i] in each time slot “i”.

Adding all difference equations of the expression (3) from a time slot 1 to a time slot i−1 allows the estimated temperature value Y[i] in the time slot “i” to be expressed by the following expression.

$$\begin{matrix}[ Expression 10 ] & \\ Y [ i ] = Y [ 1 ] + {\sum }_{i = 1}^{i - 1} ( \frac{1}{{C}_{v}} {\sum }_{k = 1}^{K} {a}_{ki} {θ}_{k} ) & ( 10 )\end{matrix}$$

Accordingly, an optimization problem of a sum total of a square error between an estimated temperature value Y[i] and an actual temperature value T[i] in each time slot “i” is expressed by the following expression.

$$\begin{matrix}[ Expression 11 ] & \\ \begin{matrix}{θ}^{*} = \begin{matrix}arg min \\ θ\end{matrix} {\sum }_{i = 1}^{I} {( Y [ i ] - T [ i ] )}^{2} \\ = \begin{matrix}arg min \\ θ\end{matrix} {\sum }_{i = 1}^{I} {\{ Y [ 1 ] + {\sum }_{j = 1}^{i - 1} ( \frac{1}{{C}_{v}} {\sum }_{k = 1}^{K} {a}_{kj} {θ}_{k} ) - T [ i ] \}}^{2}\end{matrix} & ( 11 )\end{matrix}$$

a solution of the expression (11) may be acquired by a regression method, assuming that each value in the time slot i=(1, 2, . . . , I) is regression indicating a different data point and that the “T[i]−Y[i]” is an objective variable and that the expression (12) below is an explanatory variable.

$$\begin{matrix}[ Expression 12 ] & \\ {\sum }_{j = 1}^{i - 1} ( \frac{1}{{C}_{v}} {\sum }_{k = 1}^{K} {a}_{kj} ) & ( 12 )\end{matrix}$$

In a flow where an optimum parameter group is calculated as an optimization problem, the parameter value calculator 163 calculates an optimum parameter group by using a mathematical programming problem solver based on the expression (8) or (11) instead of the processing at S103 to S107 in the flow chart illustrated in FIG. 14.

As described above, the present embodiment calculates a parameter necessary for simulation on the basis of measurement temperature that can be easily acquired. This allows a simple sensor such as a thermometer to be used, and thus it is possible to reduce a time of checking power consumption of the air conditioner 2 and the like, and a cost of providing a device for measuring electric power. In addition, a plurality of parameter candidate groups is generated to select an optimum parameter group, and thus an air conditioning model and simulation, with high accuracy, are available. Accordingly, it is possible to achieve an air conditioning operational evaluation apparatus that satisfies both economical efficiency and evaluation accuracy.

Each process in the embodiments described above can be implemented by software (program). Thus, the air conditioning operational evaluation apparatus in the embodiment described above can be implemented using, for example, a general-purpose computer apparatus as basic hardware and causing a processor mounted in the computer apparatus to execute the program.

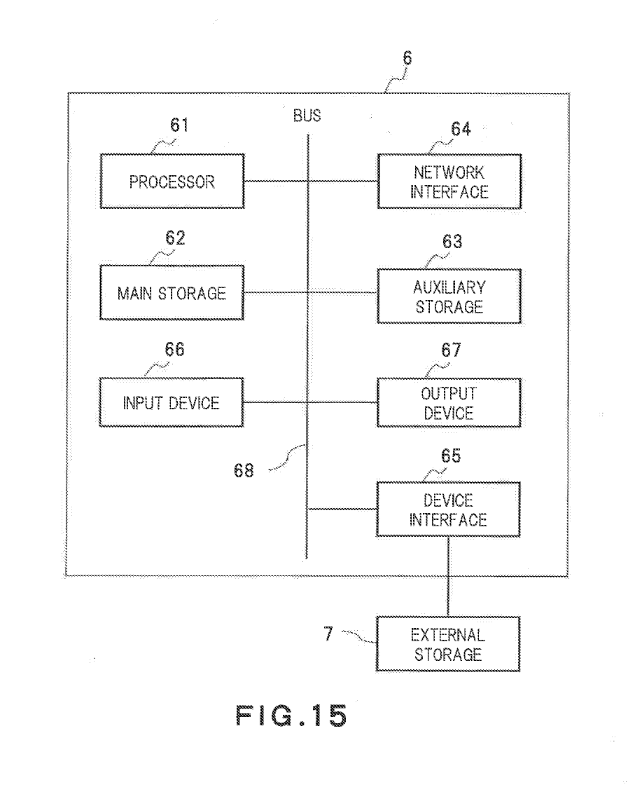

FIG. 15 is a block diagram illustrating an example of a configuration of hardware achieving the air conditioning operational evaluation apparatus according to one embodiment of the present invention. The air conditioning operational evaluation apparatus can be achieved as a computer device 6 that includes a processor 61, a main storage 62, an auxiliary storage 63, a network interface 64, a device interface 65, an input device 66, and an output device 67, and these components are connected on a bus 68.

The processor 61 reads out a program from the auxiliary storage 63, and expands the program to the main storage 62, and then executes the program to enable a function of each of the zone information generator 161, the parameter value calculator 163, the parameter candidate generator 1631, the temperature time-series estimator 1633, the optimum candidate selector 1635, and the simulator 17.

The air conditioning operational evaluation apparatus of the present embodiment may be achieved by preinstalling a program to be executed by the air conditioning operational evaluation apparatus into the computer device, or may be achieved by appropriately installing the program into the computer device by using a recording medium such as a CD-ROM that stores the program or by distributing the program through a network.

The network interface 64 is used to be connected to a communication network. Communication with the air conditioner 2, the sensor 3, and the like may be achieved through the network interface 64. While only one network interface is illustrated here, a plurality of network interfaces may be mounted.

The device interface 65 is used to be connected to a device such as an external storage (external recording medium) 7. The external storage 7 may be any recording medium or storage, such as an HDD, a CD-R, a CD-RW, a DVD-RAM, a DVD-R, and a storage area network (SAN). The positional information DB 12, the measurement result information DB 13, the air conditioner use result information DB 14, the air conditioner use calculation information DB 15, the zone information DB 162, the parameter candidate DB 1632, the estimated temperature information DB 1634, the optimum parameter DB 1636, and the simulation result DB 18, each may be connected to the device interface 65 as the external storage 7.

The input device 66 includes an input device, such as a keyboard, a mouse, and a touch panel, to achieve a function of the input device 11. The input device 11 outputs an operation signal generated by operating the input device to the processor 61. The input device 66 or the output device 67 may be connected to the device interface 65 from the outside.

The output device 67 is composed of a display such as a liquid crystal display (LCD) and a cathode ray tube (CRT) to achieve a function of the output device 19.

The main storage 62 is a memory device that temporarily stores a command to be executed by the processor 61, various kinds of data, and the like, and that may be a volatile memory such as a DRAM, or may be a nonvolatile memory such as an MRAM. The auxiliary storage 63 is used to permanently store a program, data, and the like, and is an HDD, an SSD, or the like, for example. Dada stored in the zone information DB 162, the parameter candidate DB 1632, the estimated temperature information DB 1634, the optimum parameter DB 1636, and the like, is stored in the main storage 62, the auxiliary storage 63, or the external storage 7.

The configuration of the air conditioning operational evaluation apparatus may be changed as needed. A part of the air conditioning operational evaluation apparatus, such as the air conditioning parameter generation apparatus 16, may be separated as an air conditioning parameter generation device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An air conditioning parameter generation apparatus comprising
a processor configured to execute a program to provide at least:
a heat flow detector configured to detect a heat flow flowing into or flowing out from a first region where an air conditioner adjusts air conditioning; and
a parameter value determiner configured to determine a value of a parameter for calculating a magnitude of a heat flow rate of the heat flow on the basis of change in measurement temperature of the first region.

2. The air conditioning parameter generation apparatus according to claim 1, wherein the parameter value determiner includes:
a parameter candidate generator configured to generate candidates of the value of the parameter;
a temperature time-series estimator configured to estimate time-series estimated temperature based on the candidates of the first region; and
an optimum candidate selector configured to select an optimum candidate from the candidates on the basis of the measurement temperature and the estimated temperature of the first region.

3. The air conditioning parameter generation apparatus according to claim 1, wherein
the parameter value determiner acquires an optimum value of the parameter by solving an optimization problem on the basis of:
an objective function that is based on a difference between the measurement temperature and an estimated temperature of the first region, or a difference between a variation of amount of heat estimated in accordance with the change of the measurement temperature and a variation of the heat flow rate of the heat flow of the first region; and
a constraint condition that is predetermined corresponding to a kind of the parameter.

4. The air conditioning parameter generation apparatus according to claim 1, wherein
the heat flow detector calculates the first region on the basis of Information on a facility where the air conditioner exists and Information on the air conditioner.

5. The air conditioning parameter generation apparatus according to claim 1, wherein
in a case where the first region has a plurality of temperature sensors, the heat flow detector generates divisions of the first region by dividing the first region on the basis of a position of each of the temperature sensors, and detects a heat flow flowing into or flowing out from each of the divisions.

6. The air conditioning parameter generation apparatus according to claim 1, wherein
the heat flow detector detects at least one heat flow from among the heat flow from the air conditioner, a heat flow between the first region and a region adjacent to the first region, a heat flow from fever of a living body existing in the first region, and a heat flow from sunshine which irradiate the first region.

7. An air conditioning operational evaluation apparatus comprising:
the air conditioning parameter generation apparatus according to claim 1;
a simulator configured to calculate an effect when operation of the air conditioner is changed, on the basis of the value of the parameter determined by the air conditioning parameter generation apparatus; and
an output device configured to output a simulation result by the simulator.

8. The air conditioning operational evaluation apparatus according to claim 7, further comprising:
an input device configured to receive at least one input among the information on a facility, measurement temperature of the first region, Information on the air conditioner.

9. A method of generating an air conditioning parameter by allowing a computer to execute the method comprising:
detecting a heat flow flowing into or flowing out from a first region where an air conditioner adjusts air conditioning; and
determining a value of a parameter for calculating a magnitude of a heat flow rate of the heat flow on the basis of change in measurement temperature of the first region.

10. A non-transitory computer readable medium having a computer program stored therein which causes a computer when executed by the computer, to perform processes comprising:
detecting a heat flow flowing into or flowing out from a first region where an air conditioner adjusts air conditioning; and
determining a value of a parameter for calculating a magnitude of a heat flow rate of the heat flow on the basis of change in measurement temperature of the first region.
